(19) United States
(12) Patent Application Publication
(10) Pub. No.: US 2022/0169007 A1
(43) Pub. Date: Jun. 2, 2022

(54) GENERATE IMAGES TO HAVE INTENDED JUSTIFICATIONS

(71) Applicant: Hewlett-Packard Development Company, L.P., Spring, TX (US)

(72) Inventors: Stephen Thomas Rohman, Vancouver, WA (US); Saurabh Shripad Bhide, Vancouver, WA (US); Daniel Ethan Frantz Quarto, Vancouver, WA (US)

(73) Assignee: Hewlett-Packard Development Company, L.P., Spring, TX (US)

(21) Appl. No.: 17/297,589

(22) PCT Filed: Jul. 31, 2019
(86) PCT No.: PCT/US2019/044509

§ 371 Date: May 27, 2021

(51) Int. Cl. B41J 2/045; B41J 3/36

(52) U.S. Cl. CPC B41J 2/04505; B41J 3/36; B41J 2/04586

(57) ABSTRACT

According to examples, an apparatus may include a tracking sensor, a delivery device and a controller. The controller may receive an input indicative of the apparatus being aligned to an alignment location, determine, based on input from the tracking sensor, that the apparatus has moved a predefined distance or past the predefined distance in a first direction from the alignment location, and based on a determination that the apparatus has been moved the predefined distance or past the predefined distance, cause a first feedback to be outputted to instruct a user to move the apparatus in a second direction. The controller may also, as the apparatus is moved in the second direction, cause the delivery device to generate an image that has an intended justification with respect to the alignment location.

### BACKGROUND

Portable handheld printers may selectively apply printing fluid to print images onto media as the printers are moved across the media. A user may select the locations at which images are to be printed and may initiate printing at the selected locations. As such, portable handheld printers may provide flexibility in the various types of media on which the images may be printed as well as the locations on the media at which the images may be printed.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may generate an image to have an intended justification with respect to an alignment location;

FIGS. 2A-2C, respectively, show diagrams of the example apparatus depicted in FIG. 1 and a medium on which the apparatus may be implemented at various stages of operation;

FIGS. 3A-3D respectively show diagrams of the example apparatus depicted in FIG. 1 and a medium on which the apparatus may be implemented at various stages of operation in which an image is to printed to have a right justification with respect to an alignment location;

FIG. 4 shows a flow diagram of an example method for generating an image to have an intended justification with respect to an alignment location; and

FIG. 5 shows a block diagram of an example printing apparatus that may generate an image to have an intended justification with respect to an alignment location.

### DETAILED DESCRIPTION

Disclosed herein are apparatuses, e.g., portable handheld printers, that may simplify generation of images having various intended justifications on media. That is, disclosed herein are controllers of the apparatuses that may perform operations to generate images on media such that the images may have intended justifications. Particularly, and according to examples, a controller may receive an instruction to generate an image to have a certain intended justification, e.g., center, right, or the like, with respect to an alignment location on a medium. The controller may determine a predefined distance that the apparatus is to be moved from the alignment location based on the received instruction and based on an input indicative of the apparatus being positioned in alignment with the alignment location, the controller may track the movement of the apparatus to determine whether the apparatus has been moved the predefined distance or past the predefined distance, e.g., at least the predefined distance.

Based on a determination that the apparatus has been moved the predefined distance or past the predefined distance, the controller may cause a first feedback to be outputted. The first feedback may be an audible, visual, and/or haptic feedback to notify a user that the apparatus has been moved a correct distance for the intended justification. In response to the first feedback, the apparatus may be moved toward to the alignment location and during the movement, starting from a start position, the controller may cause the apparatus to generate the image to have the intended justification with respect to the alignment location.

Through implementation of the apparatuses, controllers, and methods disclosed herein, images having intended justifications may be generated on media in a simple, yet accurate manner. That is, the controller may identify the starting location for an image to be fabricated, e.g., printed, etched, etc., with respect to an alignment location and may instruct a user to position the apparatus at the identified starting location. The apparatus may thus be positioned accurately at the starting location for the generation of the image to have the intended justification without requiring that a user identify the starting location, which may be prone to errors.

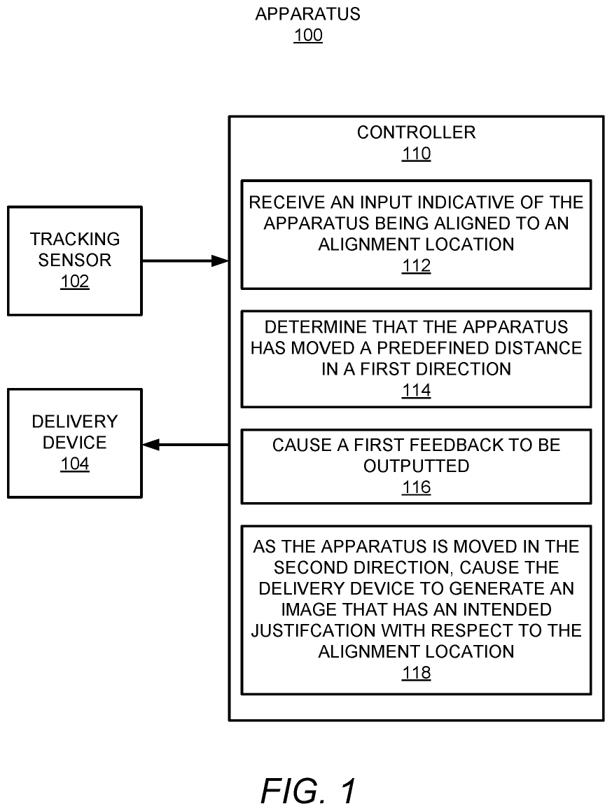

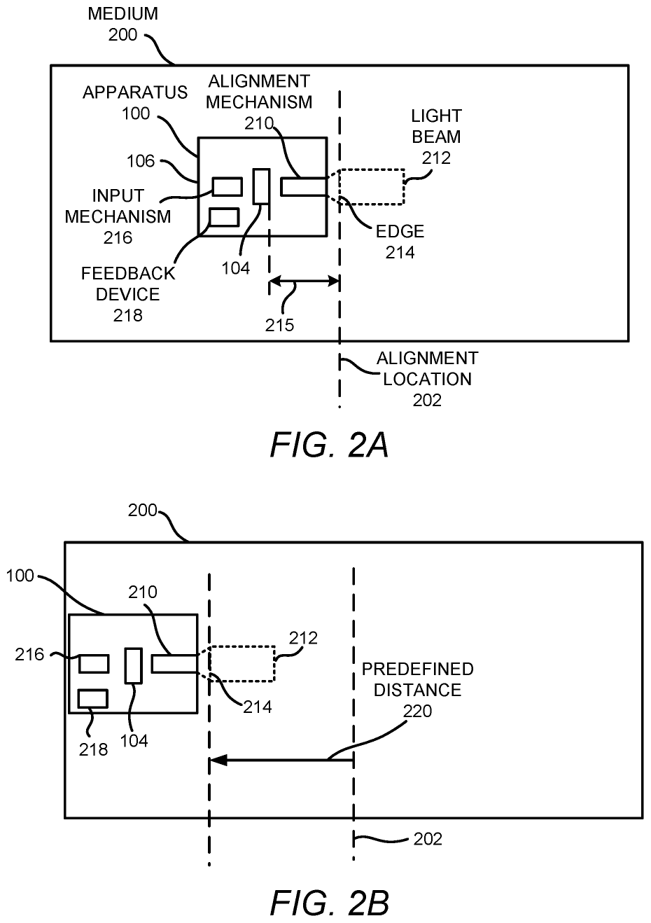

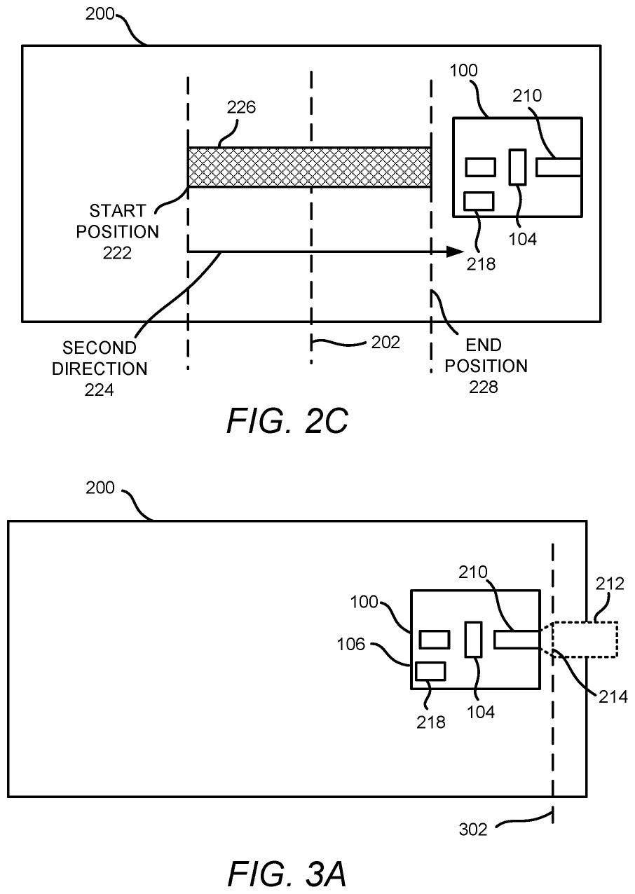

Reference is first made to FIGS. 1 and 2A-2C. FIG. 1 shows a block diagram of an example apparatus 100 that may generate an image to have an intended justification with respect to an alignment location. FIGS. 2A-2C, respectively, show diagrams of the apparatus 100 depicted in FIG. 1 and a medium 200 on which the apparatus 100 may be implemented at various stages of operation. It should be understood that the example apparatus 100 depicted in FIGS. 1 and 2A-2C may include additional features and that some of the features described herein may be removed and/or modified without departing from the scope of the apparatus 100.

The apparatus 100, which may equivalently be termed a printing apparatus 100, may be a printing device and particularly, a portable handheld printer. In this regard, the apparatus 100 may receive data pertaining to an image to be printed from an image source (not shown) and may print the image as the apparatus 100 is moved across a medium 200. The image source may be a computing device, such as a laptop computer, a smart phone, a tablet computer, or the like. In addition, although not shown, the apparatus 100 may include a communications interface through which the apparatus 100 may communicate with the image source. The communications interface may be a wireless communication interface such as Bluetooth, Wifi, near field communication, and/or the like, or a wired communication interface. By way of particular example, a user may identify an image to be printed on the image source and may cause the data pertaining to the identified image to be communicated from the image source or another source to the apparatus 100.

The user may also input an instruction into the image source regarding an intended justification that the generated, e.g., printed, image is to have on a medium 200 and more particularly, an alignment with respect to an alignment location 202. That is, the user define that the image is to be generated to have a left justification, a center justification, a right justification, or some other justification with respect to the alignment location 202 on the medium 200. The image source may further send the instruction regarding the intended justification to the apparatus 100. As discussed herein, the apparatus 100 may implement various operations to enable the image to be generated to have the intended justification with respect to the alignment location 202. The alignment location 202 may correspond to a particular location at which the user intends an image to be justified. The alignment location 202 may thus correspond to a center of a medium 200, a right edge of the medium 200, a left edge of the medium 200, or any other location between the right edge or left edge of the medium 200.

As shown in FIGS. 1 and 2A-2C, the apparatus 100 may include a tracking sensor 102, a delivery device 104, a controller 110, as well as other components as discussed in further detail below, which may be housed in a housing 106. The housing 106 may be sized such that a user may handle the housing 106 with one hand. In some examples, the housing 106 may have a cube shape or other suitable shape that may enable a user to handle the housing 106. In some examples, the apparatus 100 may be a wireless handheld printer and may thus include a battery, e.g., a rechargeable battery, that may provide power for the components included in the apparatus 100. In other examples, however, the apparatus 100 may be wired to a power source, the image source, or the like, and may receive power through the wired connection. In still other examples, the apparatus 100 may receive power wirelessly, e.g., via inductive charging.

The controller 110 may control operations of the components housed in the apparatus 100. The controller 110 may be a semiconductor-based microprocessor, a central processing unit (CPU), an application specific integrated circuit (ASIC), a field-programmable gate array (FPGA), and/or other suitable hardware device. The controller 110 may execute machine-readable instructions 112-118 (which may also be termed computer-readable instructions) in controlling the operations of the components. The instructions 112-118 may be coded into hardware of the controller 110 or may be stored in a memory (not shown) that the controller 110 may access. The memory may be an electronic, magnetic, optical, or other physical storage device that contains or stores executable instructions and may be a non-transitory machine-readable storage medium, where the term “non-transitory” does not encompass transitory propagating signals.

As shown in FIG. 1 and described with respect to FIGS. 1 and 2A-20, the controller 110 may execute the instructions 112 to receive an input indicative of the apparatus 100 being aligned to an alignment location 202. The apparatus 100 may include an alignment mechanism 210, which may include, for instance, a light source to output a light beam 212 having an edge 214. The edge 214 may correspond to, e.g., may be calibrated to, a location at which the apparatus 100 may begin to print an image as the apparatus 100 is moved in a direction toward the light beam 212. A user may use the edge 214 of the light beam 212 to align the apparatus 100 to a location at which the image is to be printed. The alignment mechanism 210 may be, for instance, a light emitting diode, a laser beam source, a light projector, and/or the like, that may output the light beam 212 to have the edge 214. In other examples, the alignment mechanism 210 may be another type of mechanism that may show the location at which the apparatus 100 may being to print as the apparatus 100 is moved.

The apparatus 100 may also include an input mechanism 216 that may be provided on a top or a side of the housing 106. The input mechanism 216 may include a physical button, a touch-sensitive pad, a microphone, and/or other mechanism 216 along with the certain circuitry and/or code through which a user may provide input into the apparatus 100. By way of example, following receipt of an instruction to print an image to have an intended justification with respect to the alignment location 202, a user may be instructed to place the apparatus 100 on the medium 200 such that the edge 214 is aligned with the alignment location 202 and to provide the input after the apparatus 100 has been so positioned. The user may be instructed to position the apparatus 100 and to provide the input via an instruction displayed or otherwise outputted via the image source. In other examples, the instruction to the user may be provided through the apparatus 100, e.g., via a display (not shown) on the apparatus 100, via voice instructions outputted from the apparatus 100, via display of the instructions by the alignment mechanism 210, and/or the like.

Following receipt of the input indicative of the apparatus 100 being aligned to the alignment location 202, the controller 110 may execute the instructions 114 to determine that the apparatus 100 has been moved a predefined distance 220 or past the predefined distance 220 (e.g., at least the predefined distance 220) in a first direction. In some examples, the user may know or otherwise may be instructed to move the apparatus 100 in a first direction away from the alignment location 202 after the user has provided the input. As shown in FIG. 2B, the apparatus 100 may be moved in the first direction as denoted by the arrow.

In addition, as the apparatus 100 is moved in the first direction, the tracking sensor 102 may track the distance that the apparatus 100 has moved. According to examples, the tracking sensor 102 may include a wheel and an encoder or other mechanism for tracking movement of the apparatus 100 and may send signals to the controller 110 indicative of the movement. The controller 110 may process the received signals to determine the distance that the apparatus 100 has traveled. The controller 110 may thus determine that the apparatus 100 has moved the predefined distance 220 or past the predefined distance 220 through processing of the received signals. As shown in FIG. 2A, the delivery device 104 may be offset from the edge 214 of the light beam 212 by an offset distance denoted by the arrow 215. Thus, when the apparatus 100 is moved in the first direction, the controller 110 may determine that the apparatus 100 has moved the predefined distance 220 or past the predefined distance when the delivery device 104 has been moved beyond a start position 222 at which the image 226 is to be generated.

As discussed herein, the predefined distance 220 may correspond to the intended justification that the printed image is to have with respect to the alignment location 202. As an example in which the intended justification is a center justification with respect to the alignment location 202, the predefined distance 220 may be equal to half of the width of the image. In this example, the predefined distance 220 may be equal to half of the width of the image minus the offset distance 215. As another example in which the intended justification is a right justification with respect to the alignment location 202, the predefined distance 220 may be equal to the width of the image. In this example, the predefined distance 220 may be equal to the width of the image minus the offset distance 215. As a further example in which the intended justification is a left justification with respect to the alignment location 202, the predefined distance 220 may be zero.

Based on a determination that the apparatus 100 has been moved the predefined distance 220 or past the predefined distance 220, the controller 110 may execute the instructions 116 to cause a first feedback to be outputted to instruct a user to move the apparatus 100 in a second direction. The controller 110 may control a feedback device 218 to output the first feedback. The feedback device 218 may be a device that may output an audible feedback, a visual feedback, and/or a haptic feedback. In this regard, the feedback device 218 may be a lighting device, a speaker, and/or a vibration device that may be housed within the housing 106. By way of example, the controller 110 may control the feedback device 218 to output a noise, spoken instructions, and/or the like to indicate to a user that the apparatus 100 has been moved to the predefined distance 220. As other examples, the controller 110 may control the feedback device 218 to display a light or a sequence of light flashes, to cause the apparatus 100 to vibrate, and/or the like indicate to a user that the apparatus 100 has been moved to the predefined distance 220.

In some examples, the user may know or otherwise may be instructed to move the apparatus 100 in a second direction 224 toward the alignment location 202 after the first feedback has been outputted. As shown in FIGS. 2B and 2C, the apparatus 100 may be considered as having traveled the defined distance 220 and may be at a start position 222 when the controller 110 causes the first feedback to be outputted. In addition, the user may begin to move the apparatus 100 in the second direction 224. As the apparatus 100 is moved in the second direction 224, the controller 110 may execute the instructions 118 to cause the delivery device 104 to generate an image 226 that has an intended justification with respect to the alignment location. Particularly, for instance, the controller 110 may control the delivery device 104 to selectively deliver printing fluid, e.g., ink or other fluid, onto the medium 200 beginning at the start position 222 and ending at an end position 228 to print the image 226 on the medium 200. As shown in FIG. 2C, the image 226 may be centered with respect to the alignment location 202.

The delivery device 104 may be any suitable type of device that may selectively cause the image 226 to be printed or otherwise formed on the medium 200. For instance, the delivery device 104 may include a thermal inkjet printhead, a piezo-electric printhead, or the like, which may be controlled to selectively deliver printing fluid via a plurality of nozzles. As other examples, the delivery device 104 may include a movable laser that may etch the image 226 onto the medium 200 through selective application of heat.

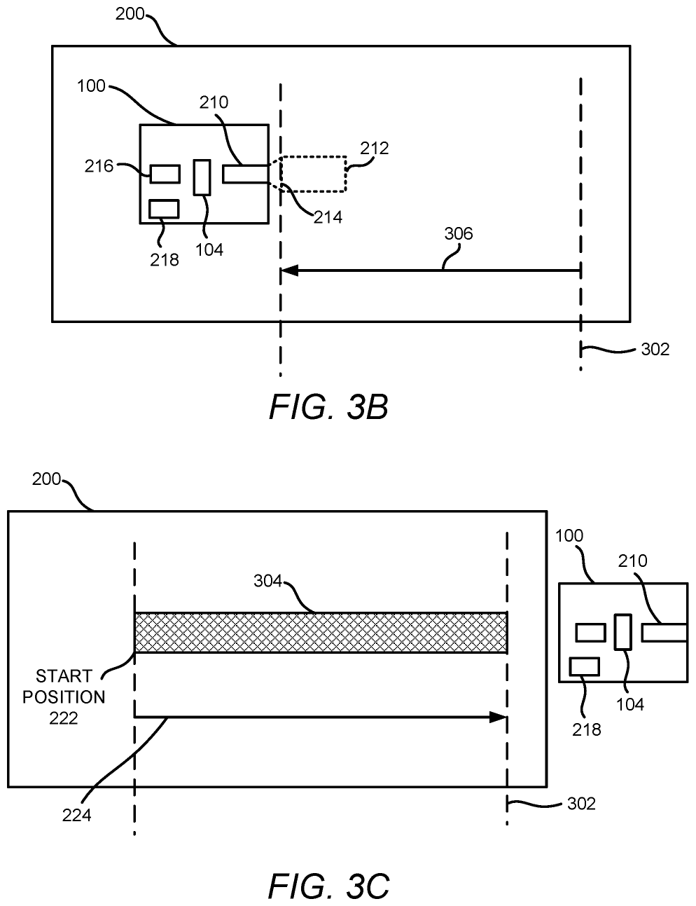

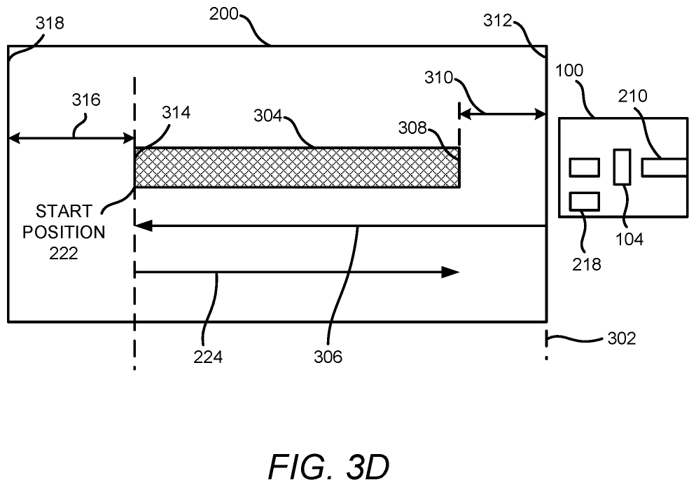

Turning now to FIGS. 3A-3D, there are respectively shown diagrams of the apparatus 100 depicted in FIG. 1 and a medium 200 on which the apparatus 100 may be implemented at various stages of operation in which an image is to printed to have a right justification with respect to an alignment location 302. As shown in FIG. 3A, the alignment location 302 is positioned closer to the right edge of the medium 200 than the alignment location 202 depicted in FIG. 2A. However, it should be understood that the alignment location 302 may be positioned anywhere a user intends for a right-justified image 304 to end.

As shown in FIG. 3A, similarly to FIG. 2A, a user may align the apparatus 100 to the alignment location 302 and may provide an input, e.g., via the input mechanism 216, that the apparatus 100 is aligned to the alignment location 302. The controller 110 may determine that the apparatus 100 has been moved a predefined distance 306 as shown in FIG. 3B and may cause the feedback device 218 to output a first feedback to indicate to the user that the apparatus 100 has been pushed a proper distance for the image 304 to be generated to have the intended justification. In contrast to the examples shown in FIGS. 2A-2C, however, the predefined distance 306 may be equal to the entire width of the image 304.

Following output of the first feedback, the user may begin moving the apparatus 100 in the second direction 224. As the apparatus 100 is moved in the second direction 224, the controller 110 may cause the delivery device 104 to generate the image 304 to have the intended justification, e.g., a right justification, with respect to the alignment location 302 beginning at the start position 222 and ending at the alignment location 302 as shown in FIG. 3C.

According to examples, the controller 110 may receive an instruction regarding the intended justification that the image 226 or 304 is to have, in which the instruction may include identification of the predefined distance 220 or 306 that the apparatus 100 is to be moved prior to starting to generate the image 226 or 304. In other examples, the controller 110 may calculate the predefined distance 220 or 304 from an instruction that identifies the width of the image 226 or 304.

According to examples, and as shown in FIG. 3D, the controller 110 may determine that an edge 308 of the generated image 304 is to end a certain distance 310 from the alignment location 302. That is, for instance, a user may input an instruction via an image source, e.g., a smartphone, a laptop, or the like, to generate the image 304 to end at the certain distance 310 from the alignment location 302. In addition, the image source may communicate the instruction to the apparatus 100. The controller 110 may add the certain distance 310 to the predefined distance 306 such that the apparatus 100 may generate the image 304 to have the certain distance 310, e.g., a margin, from the alignment location 302. Thus, for instance, the alignment location 302 may be a border 312, e.g., the right border or edge, of the medium 200 and a user may not need to measure the certain distance 310 from the border 312 in order to cause the edge 308 of the image 304 to be spaced the certain distance 310 from the border 312.

In further examples, the controller 110 may determine that the left edge 314 of the image 304 is to be generated to be left justified and have a left margin having a certain distance 316 from a left border 318 of the medium 200. In these examples, the controller 110 may begin generating the image 304 after the apparatus 100 has been moved the certain distance 316 from the left border 318 of the medium 200.

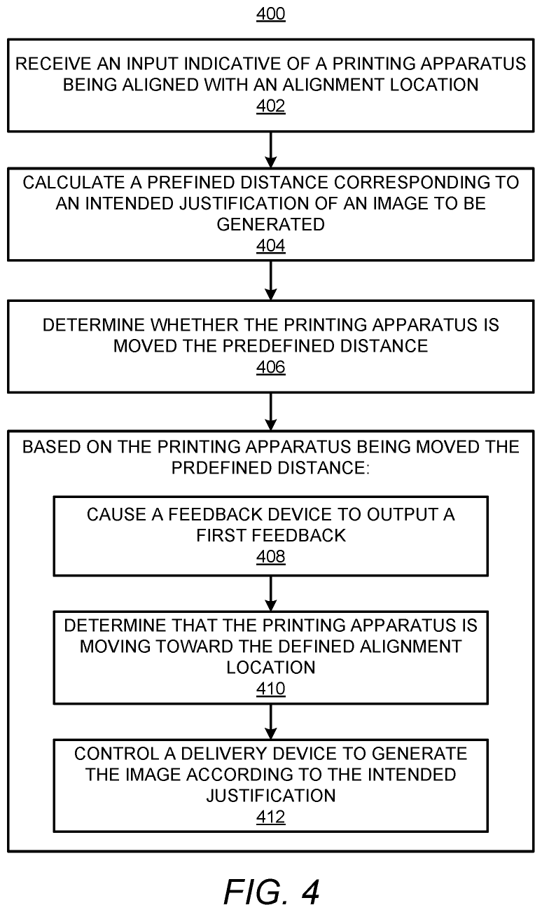

Turning now to FIG. 4, there is shown a flow diagram of an example method 400 for generating an image to have an intended justification with respect to an alignment location 202, 302. It should be understood that the method 400 depicted in FIG. 4 may include additional operations and that some of the operations described therein may be removed and/or modified without departing from the scope of the method 400. The description of the method 400 is also made with reference to the features depicted in FIGS. 1-3C for purposes of illustration. Particularly, the controller 110 of the apparatus 100 may execute some or all of the operations included in the method 400.

At block 402, the controller 110 may receive, via an input mechanism 216, an input indicative of a printing apparatus 100 being aligned with an alignment location 202, 302. The controller 110 may receive the input in any of the manners discussed herein. As also discussed herein, the controller 110 may receive the input following receipt of an instruction to print an image 226, 304 from an image source. The instruction may include an identification of features of the image 226, 304 to be generated, such as, dimensions, colors, content to be printed, and/or the like.

At block 404, the controller 110 may calculate a predefined distance 220, 306 corresponding to an intended justification of the image 226, 304 to be generated. The controller 110 may calculate the predefined distance based on the width or the height of image 226, 304 to be generated and the intended justification for the image 226, 304. For instance, the controller 110 may calculate the predefined distance 220 to be equal to half of the image 226 width in instances in which the image is to be generated with a center justification. As another example, the controller 110 may calculate the predefined distance 306 to be equal to the entire width or height of the image 226, 304 to be generated in instances in which the image is to be generated with a right justification. In other examples, however, the image source may calculate the predefined distance 220, 306 and may instruct the controller 110 with the calculated predefined distance 220, 306.

At block 406, the controller 110 may determine whether the printing apparatus 100 is moved the predefined distance 220, 306 or past the predefined distance 220, 306. Based on a determination that the printing apparatus 110 has not been moved the predefined distance 220, 306, the controller 110 may continue to track the movement, for instance, via signals received from the tracking sensor 102.

At block 408, based on a determination that the printing apparatus 100 is moved the predefined distance 220, 306 or past the predefined distance 220, 306, the controller 110 may cause a feedback device 218 to output a first feedback. In addition, at block 410, the controller 110 may determine that the printing apparatus 100 is moving toward the alignment location 202, 302 after having being moved the predefined distance 220, 306 or past the predefined distance 220, 306. Furthermore, at block 412, the controller 110 may control a delivery device 104 to generate the image according to the intended justification in any of the manners as discussed herein.

In some examples, following block 402, the controller 110 may determine that the printing apparatus 100 is being moved in an incorrect direction. An incorrect direction may be a direction other than the first direction, e.g., in a direction that is other than left of the alignment location 202, 302. In these instances, the controller 110 may, based on the determination that the printing apparatus 100 is being moved in the incorrect direction, cause the feedback device 218 to output a second feedback. The second feedback may be an audible feedback, a visual feedback, and/or a haptic feedback, and may thus be similar to the first feedback. However, the second feedback may differ from the first feedback such that the user may determine from the second feedback that the user is moving the printing apparatus 100 in the incorrect direction.

In some examples, the controller 110 may determine whether the image 226, 304 is to be one of left justified, centered justified, or right justified with respect to the alignment location 202, 302. In addition, the controller 110 may determine whether a start position 222 of the printing apparatus 100 is negative with respect to the alignment location 202, 302 based on a determination as to whether the image is to be one of left justified, centered justified, or right justified with respect to the alignment location, in which the start position 222 may correspond to the predefined distance 220, 306 from the alignment location 202, 302. That is, the controller 110 may determine that the start position 222 is negative based on a determination that the image 226, 304 is to be one of centered justified or right justified with respect to the alignment location 202, 302. Additionally, the controller 110 may determine that the start position 222 is not negative based on a determination that the image 226, 304 is to be left justified.

In addition, based on a determination that the image 226 is to be center justified, the controller 110 may calculate the start position 222 as being half of a width of the image 226 and may determine the predefined distance 220 to be equal to half of the width of the image 226. However, based on a determination that the image 304 is to be right justified, the controller 110 may calculate the start position 222 as being the width of the image 304 and may determine the predefined distance 306 to be equal to the width of the image 304.

Some or all of the operations set forth in the method 400 may be contained as utilities, programs, or subprograms, in any desired computer accessible medium. In addition, the method 400 may be embodied by computer programs, which may exist in a variety of forms. For example, the method 400 may exist as machine-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

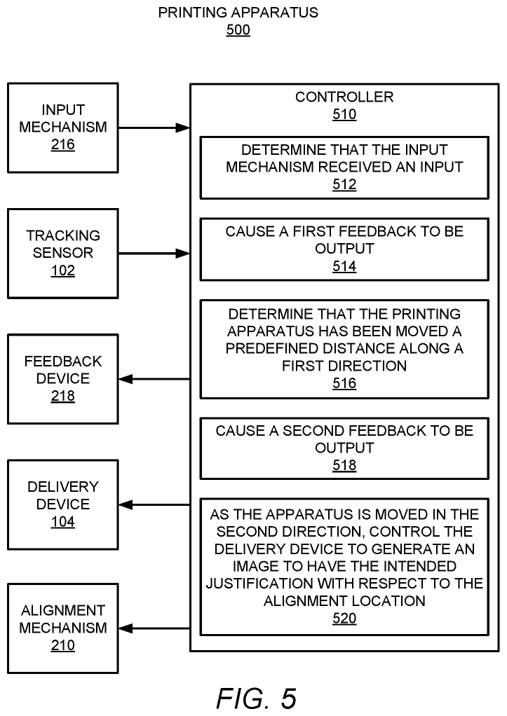

Turning now to FIG. 5, there is shown a block diagram of an example printing apparatus 500 that may generate an image 226, 304 to have an intended justification with respect to an alignment location 202, 302. It should be understood that the example apparatus 500 depicted in FIG. 5 may include additional features and that some of the features described herein may be removed and/or modified without departing from the scope of the printing apparatus 500.

As shown in FIG. 5, the printing apparatus 500 may include an input mechanism 216, a tracking sensor 102, a feedback device 218, a delivery device 104, an alignment mechanism 210, and a controller 510. The controller 510 may be similar to the controller 110 as discussed herein. As each of the components depicted in FIG. 5 are described in detail with respect to FIGS. 1-3C, the components are not described again in detail other than to describe how the components are being implemented in the printing apparatus 500.

The controller 510 may control operations of the components housed in the apparatus 500 and may execute machine-readable instructions 512-520 (which may also be termed computer readable instructions) in controlling the operations of the components. The controller 510 may execute the instructions 512 to determine that the input mechanism 216 received an input and execute the instructions 514 to cause a first feedback to be output, the first feedback to instruct a user to move the printing apparatus 500 along a first direction. That is, the controller 510 may cause the feedback device 218 to output an audible, visual, and/or haptic feedback that a user may interpret as an instruction to move the printing apparatus 500.

The controller 510 may execute the instructions 516 to determine from, e.g., signals received from, the tracking sensor 102 that the printing apparatus 500 has been moved a predefined distance 220, 306 or past the predefined distance 220, 306 along the first direction, in which the predefined distance 220, 306 may correspond to an intended justification of the image 226, 304 on a medium 200. The controller 510 may also execute the instructions 518 to cause a second feedback to be output, the second feedback to instruct a user to stop movement of the printing apparatus 500 along the first direction and to move the printing apparatus 500 along a second direction. That is, the controller 510 may cause the feedback device 218 to output an audible, visual, and/or haptic feedback that a user may interpret as an instruction to stop moving the printing apparatus 500 away from the alignment location 202, 302 and to start moving the printing apparatus 500 toward the alignment location 202, 302.

The controller 510 may execute the instructions 520 to, as the printing apparatus 500 is moved along the second direction, control the delivery device 104 to generate an image 226, 304 to have the intended justification with respect to an alignment location 202, 302 on the medium 200. The image 226, 304 may be generated via delivery of printing fluid and/or through etching or other modification to the medium 200 as discussed herein.

In some examples, the controller 510 may calculate a start position 222 of the printing apparatus 500 to be moved along the second direction as a half of a width of the image 226 based on the intended justification being a centered justification. Alternatively, the controller 510 may calculate a start position 222 of the printing apparatus 500 to be moved along the second direction as a width of the image 304 based on the intended justification being a right justification.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

For simplicity and illustrative purposes, the present disclosure is described by referring mainly to examples. In the description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

What is claimed is:

1. An apparatus comprising:
a tracking sensor;
a delivery device; and
a controller to:
receive an input indicative of the apparatus being aligned to an alignment location;
determine, based on input from the tracking sensor, that the apparatus has moved a predefined distance or past the predefined distance in a first direction from the alignment location;
based on a determination that the apparatus has been moved the predefined distance or past the predefined distance, cause a first feedback to be outputted to instruct a user to move the apparatus in a second direction; and
as the apparatus is moved in the second direction, cause the delivery device to generate an image that has an intended justification with respect to the alignment location.

2. The apparatus of claim 1, further comprising:
an alignment mechanism to output a light beam having an edge, wherein the edge of the light beam is to be aligned to the alignment location when the input indicative of the apparatus being aligned to the alignment location is received; and
wherein the predefined distance includes an offset distance between the edge of the light beam and the delivery device.

3. The apparatus of claim 1, wherein the controller is further to:
determine whether the image is to be one of left justified, center justified, or right justified with respect to the alignment location; and
determine whether a start position of the apparatus is negative with respect to the alignment location based on a determination as to whether the image is to be one of left justified, center justified, or right justified with respect to the alignment location, wherein the start position corresponds to the predefined distance in the first direction from the alignment location.

4. The apparatus of claim 3, wherein the controller is further to:
determine that the start position is negative based on a determination that the image is to be one of center justified or right justified with respect to the alignment location;
based on a determination that the image is to be center justified,
calculate the start position as being half of a width of the image;
determine the predefined distance to be equal to half of the width of the image; or
based on a determination that the image is to be right justified,
calculate the start position as being the width of the image; and
determine the predefined distance to be equal to the width of the image.

5. The apparatus of claim 1, wherein the controller is further to:
determine that an edge of the image is to end a certain distance from the alignment location; and
add the certain distance to the predefined distance to cause the image to be generated to end at the certain distance from the alignment location.

6. The apparatus of claim 1, further comprising:
a feedback device to output an audible feedback, a visual feedback, and/or a haptic feedback, wherein the controller is to control the feedback device to output the first feedback.

7. The apparatus of claim 6, wherein the controller is further to:
determine, based on input from the tracking sensor, that the apparatus has moved in a direction other than the first direction from the alignment location prior to a determination that the apparatus has been moved the predefined distance or past the predefined distance; and
control the feedback device to output a second feedback.

8. The apparatus of claim 1, further comprising:
an input mechanism, wherein the controller is to receive the input indicative of the apparatus being aligned to the alignment location based on receipt of an input from the input mechanism.

9. A method comprising:
receiving, by a controller and via an input mechanism, an input indicative of a printing apparatus being aligned with an alignment location;
calculating, by the controller, a predefined distance corresponding to an intended justification of an image to be printed;
determining, by the controller, whether the printing apparatus is moved at least the predefined distance;
based on a determination that the printing apparatus is moved at least the predefined distance, by the controller:
causing a feedback device to output a first feedback;
determining that the printing apparatus is moving toward the alignment location after having been moved at least the predefined distance; and
controlling a delivery device to generate the image according to the intended justification.

10. The method of claim 9, further comprising:
determining that the printing apparatus is being moved in an incorrect direction following receipt of the input indicative of the printing apparatus being aligned with the alignment location; and
based on the determination that the printing apparatus is being moved in the incorrect direction, cause the feedback device to output a second feedback.

11. The method of claim 9, further comprising:
determining whether the image is to be one of left justified, centered justified, or right justified with respect to the alignment location; and
determining whether a start position of the printing apparatus is negative with respect to the alignment location based on a determination as to whether the image is to be one of left justified, centered justified, or right justified with respect to the alignment location, wherein the start position corresponds to the predefined distance from the alignment location.

12. The method of claim 11, further comprising:
determining that the start position is negative based on a determination that the image is to be one of center justified or right justified with respect to the alignment location;
based on a determination that the image is to be center justified,
calculating the start position as being half of a width of the image;
determining the predefined distance to be equal to half of the width of the image; and
based on a determination that the image is to be right justified,
calculating the start position as being the width of the image; and
determining the predefined distance to be equal to the width of the image.

13. A printing apparatus comprising:
an input mechanism;
a tracking sensor to track movement of the printing apparatus;
a delivery device to generate an image;
a controller to:
determine that the input mechanism received an input;
cause a first feedback to be output, the first feedback to instruct a user to move the printing apparatus along a first direction;
determine from the tracking sensor that the printing apparatus has been moved a predefined distance or past the predefined distance along the first direction, wherein the predefined distance corresponds to an intended justification of the image on a medium;
cause a second feedback to be output, the second feedback to instruct a user to stop movement of the printing apparatus along the first direction and to move the printing apparatus along a second direction; and
as the printing apparatus is moved along the second direction, control the delivery device to generate the image to have the intended justification with respect to an alignment location on the medium.

14. The printing apparatus of claim 13, wherein the controller is further to:
calculate a start position of the printing apparatus to be moved along the second direction as a half of a width of the image based on the intended justification being a centered justification; or
calculate a start position of the printing apparatus to be moved along the second direction as a width of the image based on the intended justification being a right justification.

15. The printing apparatus of claim 13, further comprising:
a feedback device to output an audible feedback, a visual feedback, and/or a haptic feedback, wherein the controller is to control the feedback device to output the first feedback and the second feedback.
